(19) United States
(12) Patent Application Publication
(10) Pub. No.: US 2012/0093327 A1
(43) Pub. Date: Apr. 19, 2012

(54) ANCHOR MODEL ADAPTATION DEVICE, INTEGRATED CIRCUIT, AV (AUDIO VIDEO) DEVICE, ONLINE SELF-ADAPTATION METHOD, AND PROGRAM THEREFOR

(76) Inventors: Lei Jia, Beijing (CN); Bingqi Zhang, Beijing (CN); Haifeng Shen, Beijing (CN); Long Ma, Beijing (CN); Tomohiro Konuma, Osaka (JP)

(21) Appl. No.: 13/379,827

(22) PCT Filed: Apr. 19, 2011
(86) PCT No.: PCT/JP2011/002298

§ 371 Date: Dec. 21, 2011

(30) Foreign Application Priority Data
Apr. 22, 2010 (CN) 201010155674.0

(51) Int. Cl. H04R 29/00

(52) U.S. Cl. 381/56

(57) ABSTRACT

The present invention provides a device that performs online self-adaption of anchor models for an acoustic space, and a method thereof, the anchor models being used for categorization of an AV stream which is performed based on an audio stream in the AV stream. The device divides an input audio stream into audio segments, each being estimated to have a single acoustic feature, and estimates a single probability model for each audio segment. Then, the device performs clustering on the estimated probability models and probability models stored therein, thereby generating a new anchor model.

### TECHNICAL FIELD

The present invention relates to online adaptation of anchor models for an acoustic space.

### BACKGROUND ART

In recent years, playback devices (e.g., DVD players, BD players, etc.) and recording devices (e.g., movie cameras) have increased in storage capacity, allowing storage of a large quantity of video contents. Along with an increase in the quantity of video contents, there is a demand for such devices to easily categorize these video contents without imposing a burden on users. One method is for such devices to generate a digest video for each video content so that the user can easily recognize the video content.

As an indicator for categorization or generation of a digest video as described above, an audio stream of a video content may be used. This is because there is a close relationship between a video content and an audio stream thereof. For example, a video content related to children inevitably includes the voices of the children, and a video content captured at a beach includes a high proportion of the sound of waves. Accordingly, video contents can be categorized according to the features of the sounds of the video contents.

There are mainly three types of methods for categorizing video contents with use of audio streams.

One method is to store sound models, which are generated based on sound segments having sound features, and to categorize a video content according to the degree (likelihood) of relationship between the sound models and sound features included in the audio stream of the video content. Here, probability models are based on various characteristic sounds such as the laughter of children, the sound of waves, and the sound of fireworks. If, for example, the audio stream of a video content is judged to include a high proportion of the sound of waves, the video content is categorized as a content pertaining to a beach.

A second method is to categorize a video content as follows. First, anchor models for an acoustic space (i.e., models representing various sounds) are established. Next, audio information of the audio stream of the video content is projected to the acoustic space, and whereby a model is generated. Then, the distance between the model generated by the projection and each of the established anchor models is calculated so as to categorize the video content.

A third method is to use a distance different from the distance described in the second method, i.e., the distance between the model generated by the projection and each of the established anchor models. For example, the third method uses Kullback-Leibler (KL) divergence or divergence distance.

In any of the first to the third methods, sound models (anchor models) are required for categorization. To generate the sound models, it is necessary to collect a certain quantity of video contents for training. This is because training needs to be carried out with use of the audio streams of the collected video contents.

There are two methods for building sound models. According to a first method, a system developer collects similar sounds, and generates a Gaussian mixture model (GMM) of the similar sounds. According to a second method, a device appropriately selects some of randomly collected sounds, and generates an anchor model for an acoustic space based on the selected sounds.

The first method has already been applied to language identification, image identification, etc., and there are many cases where categorization has been successfully performed with use of the first method. In the case of generating a Gaussian mixture model to build a sound model for a sound or a video according to the first method, maximum likelihood method (MLE: Maximum Likelihood Estimation) is used to estimate parameters of the sound model. The sound model (Gaussian mixture model) after training is required to disregard secondary features, and to accurately describe the feature of the type of the sound or the video for which the sound model needs to be built.

Regarding the second method, an anchor model to be generated is required to express the broadest acoustic space possible. In the second method, a parameter of a model is estimated with use of: clustering by means of K-means method; LBG method (Linde-Buzo-Gray algorithm); or EM method (Estimation Maximization algorithm).

Patent Literature 1 discloses a method for extracting a highlight of a video with use of the first method out of the aforementioned two methods. According to Patent Literature 1, a video is categorized with use of sound models for handclaps, cheering, a sound of a batted ball, music, and so on, and a highlight is extracted from the categorized video.

### CITATION LIST

### Patent Literature

Patent Literature 1: Japanese Patent Application Publication No. 2004-258659

### SUMMARY OF INVENTION

### Technical Problem

In categorizing video contents as described above, an audio stream of a video content targeted for categorization may be inconsistent with anchor models stored in advance. In other words, the type of an audio stream of a video content targeted for categorization may not be accurately specified or may not be appropriately categorized with use of anchor models stored in advance. Such inconsistency is not preferable since it leads to poor system performance or low reliability.

Accordingly, a technology is necessary that adjusts an anchor model based on an input audio stream. The technology for adjusting an anchor model is often referred to as an online adaptation method in the present technical field.

However, a conventional online adaptation method has the following problem. According to the conventional online adaptation method, adaptation of an acoustic space model represented by anchor models is performed with use of MAP (Maximum-A-Posteriori estimation method) and MLLR (Maximum Likelihood Linear Regression) which are based on the maximum likelihood method. However, although adaptation of the acoustic space model is performed, sounds outside the acoustic space model can never be appropriately evaluated or cannot be appropriately evaluated unless adequate time is provided for evaluation.

The following describes this problem in details. Suppose that an audio stream has a certain length and includes a low proportion of a sound having a certain feature. Also, suppose that sound models prepared in advance do not match the sound having the certain feature. In this case, adaptation of the sound models becomes necessary in order to correctly evaluate the sound having the certain feature. However, in the case of the maximum likelihood method, if the proportion of the sound having the certain feature is low with respect to the audio stream having the certain length (i.e., if the sound has a shorter length than the audio stream), the sound is not sufficiently reflected on the sound models. Specifically, suppose that a video content having a length of one hour includes a sound of a crying baby for about 30 seconds, and that there is no anchor model that corresponds to any sound of crying. In this case, since the length of crying of the baby is short with respect to the length of the video content, the sound of crying is not sufficiently reflected on an anchor model even after adaptation of the anchor model is performed. This means that although the sound of the crying baby is attempted to be matched again with the sound models prepared in advance, the sound still does not match any of the sound models and cannot be evaluated appropriately.

The present invention has been achieved in view of the above problem, and an aim thereof is to provide an anchor model adaptation device capable of performing, on an anchor model for an acoustic space, online adaptation more appropriately than in conventional technology, an anchor model adaptation method, and a program thereof.

### Solution to Problem

In order to solve the above problem, the present invention provides an anchor model adaptation device comprising: a storage unit storing therein a plurality of anchor models each composed of a different set of probability models, each probability model being generated from a sound having a single acoustic feature; an input unit configured to receive an input of an audio stream; a division unit configured to divide the audio stream into a plurality of audio segments, each being estimated to have a single acoustic feature; an estimation unit configured to estimate a probability model for each audio segment; and a clustering unit configured to perform clustering on the probability models constituting the anchor models in the storage unit and the probability models estimated by the estimation unit, and thereby to generate a new anchor model.

Also, the present invention provides an online adaptation method for anchor models used in an anchor model adaptation device including a storage unit storing therein a plurality of anchor models each composed of a different set of probability models, each probability model being generated from a sound having a single acoustic feature, the online adaptation method comprising: an input step of receiving an input of an audio stream; a division step of dividing the audio stream into a plurality of audio segments, each being estimated to have a single acoustic feature; an estimation step of estimating a probability model for each audio segment; and a clustering step of performing clustering on the probability models constituting the anchor models in the storage unit and the probability models estimated by the estimation step, and thereby of generating a new anchor model.

Here, the online adaptation refers to adaptation (generation and correction) of an anchor model representing an acoustic feature. The adaptation is for enabling the anchor model to represent the acoustic space more appropriately, and is performed according to an input audio stream. In the present application, the term “online adaptation” is used in this sense.

Also, the present invention provides an integrated circuit comprising: a storage unit storing therein a plurality of anchor models each composed of a different set of probability models, each probability model being generated from a sound having a single acoustic feature; an input unit configured to receive an input of an audio stream; a division unit configured to divide the audio stream into a plurality of audio segments, each being estimated to have a single acoustic feature; an estimation unit configured to estimate a probability model for each audio segment; and a clustering unit configured to perform clustering on the probability models constituting the anchor models in the storage unit and the probability models estimated by the estimation unit, and thereby to generate a new anchor model.

Also, the present invention provides an audio video device comprising: a storage unit storing therein a plurality of anchor models each composed of a different set of probability models, each probability model being generated from a sound having a single acoustic feature; an input unit configured to receive an input of an audio stream; a division unit configured to divide the audio stream into a plurality of audio segments, each being estimated to have a single acoustic feature; an estimation unit configured to estimate a probability model for each audio segment; and a clustering unit configured to perform clustering on the probability models constituting the anchor models in the storage unit and the probability models estimated by the estimation unit, and thereby to generate a new anchor model.

Also, the present invention provides an online adaptation program indicating a processing procedure for causing a computer to perform online adaptation for anchor models, the computer including a memory storing therein a plurality of anchor models each composed of a different set of probability models, each probability model being generated from a sound having a single acoustic feature, the processing procedure comprising: an input step of receiving an input of an audio stream; a division step of dividing the audio stream into a plurality of audio segments, each being estimated to have a single acoustic feature; an estimation step of estimating a probability model for each audio segment; and a clustering step of performing clustering on the probability models constituting the anchor models in the memory and the probability models estimated by the estimation step, and thereby of generating a new anchor model.

### Advantageous Effects of Invention

With the stated structure, the anchor model adaptation device generates a new anchor model from anchor models already stored therein and probability models estimated based on an input audio stream. In other words, the anchor model adaptation device generates a new anchor model according to an input audio stream, instead of just slightly correcting the pre-stored anchor models. This enables the anchor model adaptation device to generate an anchor model that covers an acoustic space suitable for the tendency of user preference in audio and video, when the user records audio and video with use of an audio video device, etc. in which the anchor model adaptation device is mounted. The use of the anchor model generated by the anchor model adaptation device produces some advantageous effects. For example, video data input by a user according to his/her preference is appropriately categorized.

### BRIEF DESCRIPTION OF DRAWINGS

FIG. 1 is an image showing an acoustic space model represented by anchor models.

FIG. 2 is a block diagram showing an example of the functional structure of an anchor model adaptation device.

FIG. 3 is a flowchart showing the overall flow of adaptation of an anchor model.

FIG. 4 is a flowchart showing a specific example of an operation of generating a new anchor model.

FIG. 5 is an image showing an acoustic space model in which new Gaussian models have been added.

FIG. 6 is an image of an acoustic space model represented by anchor models generated with use of an anchor model adaptation method according to the present invention.

### DESCRIPTION OF EMBODIMENT

### Embodiment

The following describes an anchor model adaptation device according to an embodiment of the present invention, with reference to the drawings.

The present embodiment employs an anchor model for an acoustic space. Although there are many kinds of anchor models for representing an acoustic space, the basic idea of the anchor models is to fully cover the acoustic space with use of the anchor models. The acoustic space is represented by a coordinate system which is a combination of spatial coordinate systems similar to a coordinate system. Two arbitrary segments of an audio file, each of which has a different acoustic feature, are mapped to two different points in the coordinate system.

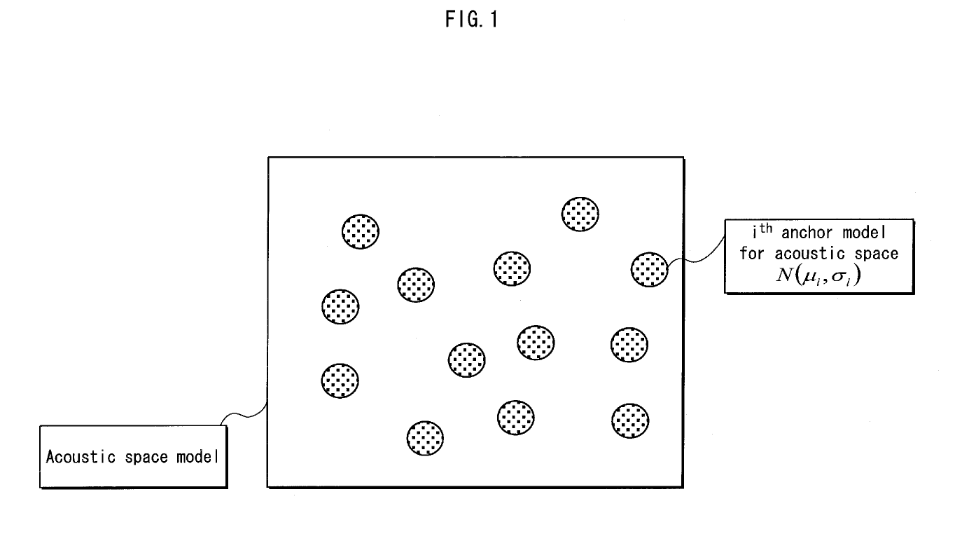

FIG. 1 shows an example of anchor models for an acoustic space according to the present embodiment. In this example, acoustic features of an AV stream are indicated with use of a plurality of Gaussian models for the acoustic space.

According to the present embodiment, an AV stream is either an audio stream or a video stream including an audio stream.

FIG. 1 shows an image of the anchor models and the acoustic space. Provided that the rectangular frame is the acoustic space, each circle in the acoustic space is a cluster (i.e., subset) having a similar acoustic feature. Each point within the respective clusters represents one Gaussian model.

As shown in FIG. 1, Gaussian models having similar features are indicated at similar positions in the acoustic space, and the set of these models forms one cluster, i.e., anchor model. The present embodiment employs a UBM (Universal Background Model) as an anchor model for a sound. A UBM, which is a set of many single Gaussian models, can be expressed by the formula (1) below.

<Formula 1>

{N(μᵢ,σᵢ)|N≧i≧1} (1)

Here, μᵢ indicates the mean of the i^{th} Gaussian model of the UBM model. Also, σᵢ indicates the variance of the i^{th} Gaussian model of the UBM model. Each Gaussian model represents a sub-area in the acoustic space, which is a partial area in the acoustic space corresponding to the mean of the Gaussian model. The Gaussian models representing these sub-areas form a single UBM. UBM models specifically represent the entirety of the acoustic space.

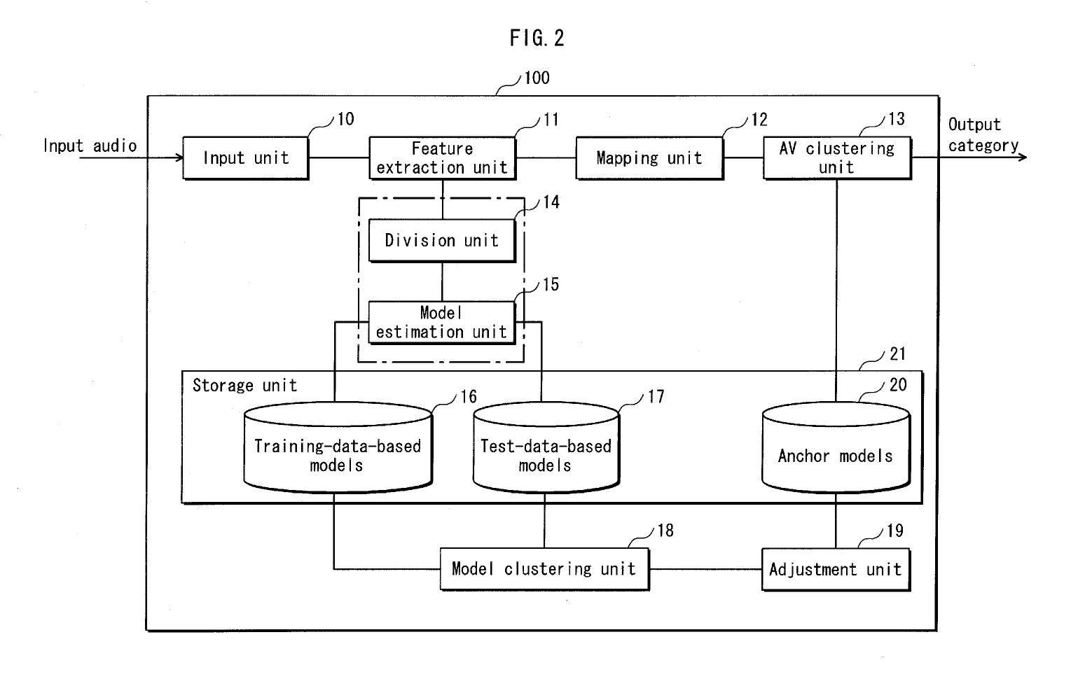

FIG. 2 is a block diagram showing the functional structure of an anchor model adaptation device 100.

As shown in FIG. 2, the anchor model adaptation device 100 includes an input unit 10, a feature extraction unit 11, a mapping unit 12, an AV clustering unit 13, a division unit 14, a model estimation unit 15, a model clustering unit 18, and an adjustment unit 19.

The input unit 10 receives input of an audio stream of an AV content, and transmits the audio stream to the feature extraction unit 11.

The feature extraction unit 11 extracts acoustic features from the audio stream transmitted from the input unit 10. Also, the feature extraction unit 11 transmits the extracted features to the mapping unit 12 and the division unit 14. Upon receiving the audio stream, the feature extraction unit 11 specifies a feature of the audio stream at predetermined time intervals (e.g., extremely short time intervals such as every 10 milliseconds).

The mapping unit 12 maps the features of the audio stream to the acoustic space model, based on the features transmitted from the feature extraction unit 11. In the present embodiment, the mapping refers to calculating, for each frame within the current audio segment, the posteriori probability of the feature of the frame with respect to an anchor model for the acoustic space, adding the posteriori probabilities of the respective frames and thereby obtaining an additional value, and dividing the additional value by the total of the frames used for calculation.

The AV clustering unit 13 performs clustering based on the features mapped by the mapping unit 12 and anchor models 20 stored in a storage unit 21 in advance. As a result of clustering, the AV clustering unit 13 specifies the category of the audio stream, and outputs the specified category. The AV clustering unit 13 performs the clustering based on a distance between adjacent audio segments, with use of an arbitrary clustering algorithm. According to the present embodiment, clustering is performed with use of a method in which features are successively merged from bottom to top.

Here, the distance between two audio segments is calculated by means of (i) mapping of the two segments to the anchor models for the acoustic space and (ii) the anchor models for the acoustic space. Each audio segment is represented by a Gaussian model group which is formed by Gaussian models (i.e., probability models) included in the anchor models stored in the anchor model adaptation device 100. The Gaussian model group of each audio segment is weighted by the audio segment being mapped to an anchor model for the acoustic space. In this way, the distance between audio segments is defined by the distance between two weighted Gaussian model groups. To measure the distance, a so-called KL (Kullback-Leibler) divergence is commonly used. The KL divergence is used to calculate the distance between the two audio segments.

According to the aforementioned clustering method, if the entirety of the acoustic space is fully covered by anchor models, it is possible to map two arbitrary audio segments to the anchor models 20 that are stored in the storage unit 21 and represent the acoustic space, by calculating the distance between the audio segments. In practice, the anchor models 20 stored in the storage unit 21 do not always cover the entirety of the acoustic space. Accordingly, the anchor model adaptation device 100 in the present embodiment performs online adaptation of anchor models in order to appropriately represent an input audio stream.

The division unit 14 divides the audio stream input to the feature extraction unit 11, based on the features transmitted from the feature extraction unit 11. Specifically, the division unit 14 divides the audio stream into audio segments along a time axis, each audio segment being estimated to have a single acoustic feature. The division unit 14 associates the audio segments with the features thereof, and transmits the audio segments and the features to the model estimation unit 15. Note that the time length of each audio segment obtained by the division may not be uniform. Also, each audio segment can be considered as a single acoustic feature or a single sound event (e.g., the sound of fireworks, the chatter of people, crying of a child, the sound of a sports festival, etc).

Upon receiving an audio stream, the division unit 14 divides the audio stream into audio segments along the time axis. Specifically, the division by the division unit 14 is performed as follows. First, the division unit 14 continuously slides a sliding window having a predetermined length (e.g., 100 milliseconds) along the time axis. Upon detecting a point at which an acoustic feature greatly changes, the division unit 14 regards the point as a change point of the acoustic feature and divides the audio stream at the change point.

The division unit 14 slides the sliding window at a predetermined step length (i.e., duration), measures a change point at which an acoustic feature changes greatly, and divides the audio stream into audio segments. At each slide, the midpoint of the sliding window may serve as a single divisional point. Here, the divergence of the divisional points (hereinafter, also referred to as “divisional divergence”) is defined as follows. Oᵢ₊₁, Oᵢ₊₂, . . . , O_{i+T} represent data pieces of speech acoustic features within a sliding window having a length of T, where i is the current start point of the sliding window. The divisional divergence of divisional points (i.e., midpoint of the sliding window) is defined in the following formula (2), where Σ denotes the variance of data pieces Oᵢ₊₁, Oᵢ₊₂, . . . , O_{i+T}, Σ₁ denotes the variance of data pieces Oᵢ₊₁, Oᵢ₊₂, . . . , O_{i+T/2}, and Σ₂ denotes the variance of data pieces O_{i+T/2+1}, O_{i+T/2+2}, . . . , O_{i+T}.

<Formula 2>

divisional divergence=log(Σ)−(log(Σ₁)+log(Σ₂)) (2)

The greater the divisional divergence is, the greater the effect is of acoustic features of data pieces that are within the sliding window and at both ends of the sliding window along the time axis. This means that the acoustic features at both ends of the sliding window along the time axis are highly likely to be different from each other. Accordingly, the midpoint of the sliding window at this position becomes a candidate as a divisional point. Finally, the division unit 14 selects a divisional point having a divisional divergence greater than a predetermined value and, based on the divisional point, divides the audio stream into audio segments that each have a single acoustic feature.

Based on an audio segment and a feature thereof transmitted from the division unit 14, the model estimation unit 15 estimates one Gaussian model of the audio segment. The model estimation unit 15 estimates a Gaussian model for each audio segment, and adds the Gaussian models to test-data-based models 17 stored in the storage unit 21.

The following describes in details estimation of Gaussian models performed by the model estimation unit 15.

When audio segments are obtained by the division unit 14, the model estimation unit 15 estimates a single Gaussian model for each of the audio segments. Here, data frames of each audio segment having a single acoustic feature are defined as Oₜ, Oₜ₊₁, . . . , Oₜ₊ₗₑₙ. In this case, the mean parameter and variance parameter of each of the single Gaussian models corresponding to Oₜ, Oₜ₊₁, . . . , Oₜ₊ₗₑₙ are estimated with use of the following formulas (3) and (4), respectively.

$$\begin{matrix}〈 Formula 3 〉 & \\ μ = {\sum }_{k = t}^{t + len} {O}_{k} & ( 3 ) \\ 〈 Formula 4 〉 & \\ Σ = {\sum }_{k = t}^{t + len} \frac{( {O}_{k} - μ )}{len} & ( 4 )\end{matrix}$$

A single Gaussian model is expressed by the mean parameter and the variance parameter shown in the formulas (3) and (4).

The model clustering unit 18 performs clustering on training-data-based models 16 in the storage unit 21 and the test-data-based models 17 in the storage unit 21. The clustering is performed with use of an arbitrary clustering algorithm.

The following specifically describes clustering performed by the model clustering unit 18.

The adjustment unit 19 adjusts anchor models generated as a result of clustering by the model clustering unit 18. In the present embodiment, the adjustment by the adjustment unit 19 refers to dividing the anchor models so as to obtain a predetermined number of anchor models. The adjustment unit 19 adds the anchor models thus adjusted to the anchor models 20 in the storage unit 21.

The storage unit 21 stores data necessary for the anchor model adaptation device 100 to perform operations. The storage unit 21 may include a ROM (Read Only Memory) or a RAM (Random Access Memory), and is realized by an HDD (Hard Disc Drive), for example. The storage unit 21 stores therein the training-data-based models 16, the test-data-based models 17, and the anchor models 20. Note that the training-data-based models 16 are the same as the anchor models 20. When online adaptation is performed, the training-data-based models 16 are updated with the anchor models 20.

<Operations>

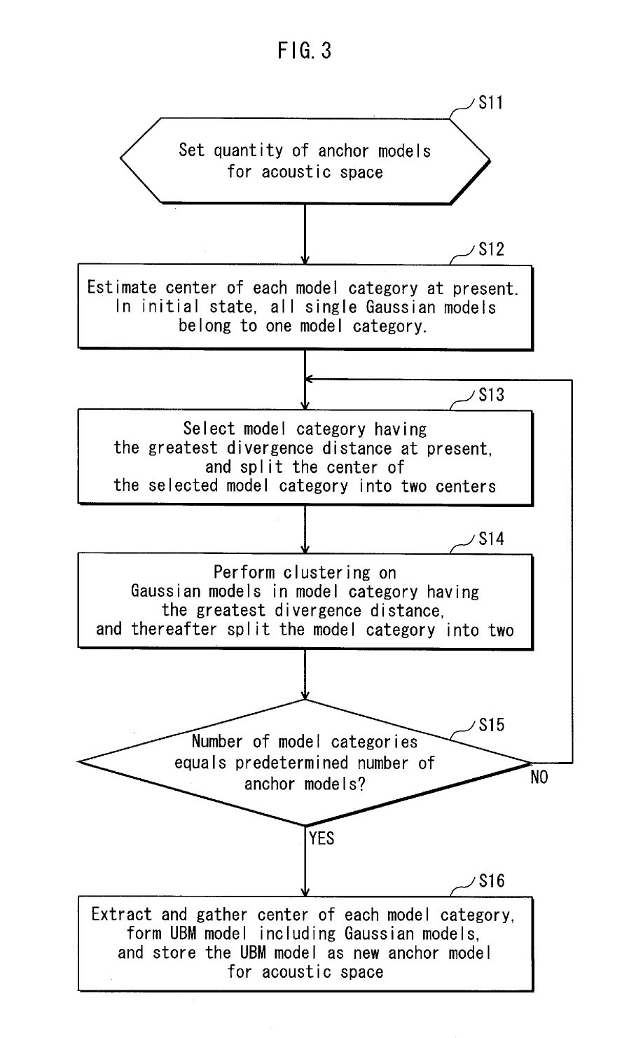

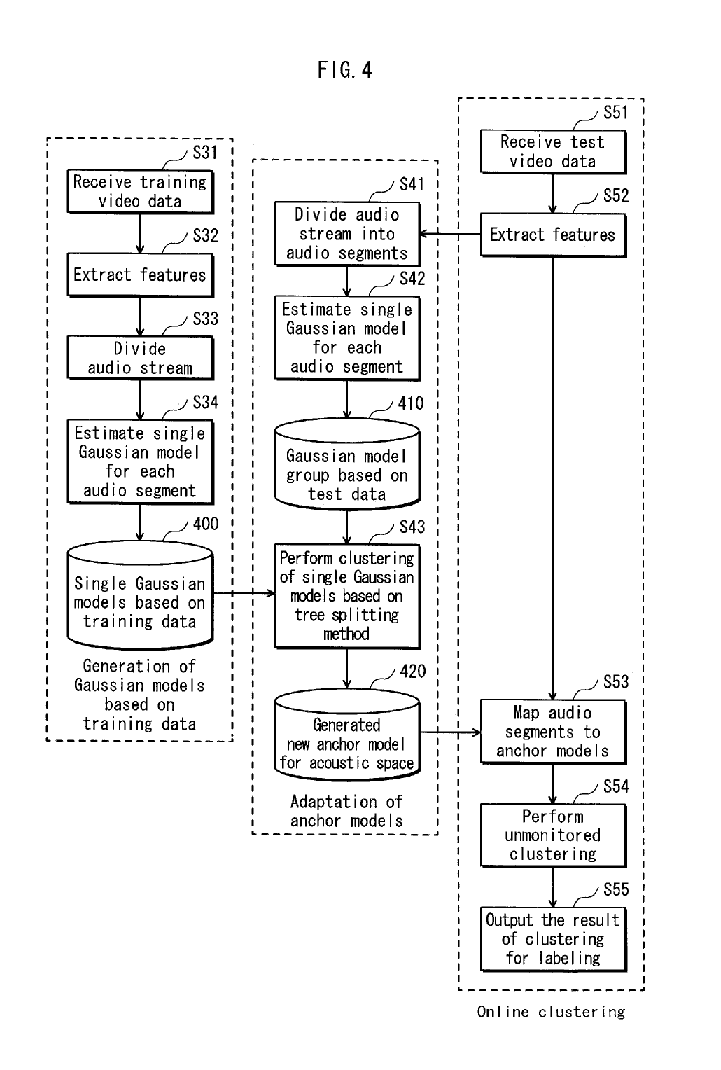

The following describes operations in the present embodiment, with use of flowcharts shown in FIGS. 3 and 4.

First, the flowchart of FIG. 3 is used to describe an online adaptation method performed by the model clustering unit 18, as a method for online adaptation by the anchor model adaptation device 100.

The model clustering unit 18 performs high-speed clustering of single Gaussian models based on a tree splitting method from top to bottom.

In step S11, the model clustering unit 18 sets the quantity (number) of anchor models for the acoustic space, which are to be generated by online adaptation. For example, the model clustering unit 18 sets the number of anchor models to 512. It is assumed that the number of anchor models is determined in advance. Setting the quantity of anchor models for the acoustic space means determining the number of model categories into which all single Gaussian models are classified.

In step S12, the model clustering unit 18 determines the center of each model category. Note that since there is only one model category in the initial state, all the single Gaussian models belong to the model category. Also, in a case where there are two or more model categories, each single Gaussian model belongs to a corresponding one of the model categories. Here, model categories at present are expressed in the following formula (5).

<Formula 5>

{ωᵢN(μᵢΣᵢ)|1≦i≦N} (5)

In the formula (5), ωi denotes the weight of the model category of single Gaussian models. The weight ωi of the model category of single Gaussian models is predetermined based on a degree of importance of a sound event represented by the single Gaussian models. The center of the model category expressed by the formula (5) above is calculated with use of the formulas (6) and (7) below. A single Gaussian model is expressed by a mean parameter and a variance parameter. Accordingly, the center of the model category is expressed by the formula (6) and the formula (7) which correspond to the mean parameter and the variance parameter, respectively.

$$\begin{matrix}〈 Formula 6 〉 & \\ {μ}_{center} = \frac{{\sum }_{i = 1}^{N} {ω}_{i} {μ}_{i}}{{\sum }_{i = 1}^{N} {ω}_{i}} & ( 6 ) \\ 〈 Formula 7 〉 & \\ {Σ}_{center} = \frac{{\sum }_{i = 1}^{N} {ω}_{i} {Σ}_{i}}{{\sum }_{i = 1}^{N} {ω}_{i}} = \frac{{\sum }_{i = 1}^{N} {ω}_{i} ( {μ}_{i} - {μ}_{center} ) ( {μ}_{i} - {μ}_{center} )}{{\sum }_{i = 1}^{N} {ω}_{i}} & ( 7 )\end{matrix}$$

In step S13, the above formulas are used to select a model category having the greatest divergence, and the center of the model category is split into two centers. Here, splitting the center into two centers means generating, from the center of the model category, two new centers for two new model categories.

In splitting the center of the model category into two centers, the distance between two Gaussian models is defined first. Here, the KL divergence is regarded as the distance between a Gaussian model f and a Gaussian model g, and is expressed in the following formula (8).

$$\begin{matrix}〈 Formula 8 〉 & \\ KLD ( f \vert g ) = 0.5 \{ log \vert \frac{{Σ}_{g}}{{Σ}_{f}} \vert + Tr ( {Σ}_{g}^{- 1} {Σ}_{f} ) + ( {μ}_{f} - {μ}_{g} ) {{Σ}_{g}^{- 1} ( {μ}_{f} - {μ}_{g} )}^{T} \} & ( 8 )\end{matrix}$$

Assume here that the model categories at present are expressed in the following formula (9).

<Formula 9>

{ωᵢN(μᵢ,Σᵢ)|1≦i≦N_{curClass}} (9)

In the above formula (9), N_{curClass} denotes the number of model categories at present. In this case, the divergence of each model category at present is defined by the following formula (10).

$$\begin{matrix}〈 Formula 10 〉 & \\ Div = \frac{{\sum }_{i = 1}^{{N}_{curClass}} {ω}_{i} \times KLD ( center , i )}{{\sum }_{i = 1}^{{N}_{curClass}} {ω}_{i}} & ( 10 )\end{matrix}$$

Divergence is calculated for each of the model categories existing at present, i.e., for each of the model categories existing at the time of the splitting processing of the model categories. Then, among the divergence values thus calculated, a model category having the largest divergence value is detected. The model clustering unit 18 fixes the variance and weight of the model category to be constant, and splits the center of the model category into two centers of two new model categories. Specifically, the center of each of the two new model categories is calculated with use of the following formula (11).

<Formula 11>

μ₁=μ_{center}+0.001×μ_{center}

μ₂=μ_{center}−0.001×μ_{center} (11)

In step S14, Gaussian model clustering using the K-means method based on Gaussian models is performed on the model category whose center has been split into two. As an algorithm for calculating the distance, the aforementioned KL divergence is employed. For the update of model categories, the model center updating formula (see formula (11)) in step S12 is used. Upon completion of the clustering of Gaussian models using the K-means method, a model category is split into two model categories and, accordingly, two model centers are generated.

In step S15, the model clustering unit 18 judges whether the number of model categories at present has reached a predetermined quantity (number) of anchor models for the acoustic space. If judging negatively, i.e., the number of model categories at present has not reached the predetermined quantity (number), the model clustering unit 18 returns to the processing of step S13. If judging affirmatively, the model clustering unit 18 ends the processing.

In step S16, the model clustering unit 18 extracts and gathers the center of each model category, thereby forming a UBM model including a plurality of Gaussian models. The UBM model is stored in the storage unit 21 as a new anchor model for the acoustic space.

The anchor model for the acoustic space at present is generated by adaptation, and is therefore different from an anchor model previously used for the acoustic space. Accordingly, processing for smoothing and adjusting is performed to establish the relationship between the two anchor models and to increase the robustness of the anchor models. The processing for smoothing and adjusting refers to merging of single Gaussian models that each have a divergence value less than a predetermined threshold value. Also, merging as described above means merging (combining) the single Gaussian models that each have a divergence value less than the predetermined threshold value into one model.

FIG. 4 is a flowchart showing a method for performing online anchor adaptation for the acoustic space, and a method for performing clustering for an audio stream, according to the present embodiment. Note that FIG. 4 also shows a process of generating, based on training data, the training-data-based models 16 that need to be stored by the time of shipment of the anchor model adaptation device 100 from a factory.

In FIG. 4, steps S31-S34 on the left side show the process of generating single Gaussian models based on training data, with use of a collection of training video data pieces.

In step S31, training data, which is video data used for training, is input to the input unit 10 of the anchor model adaptation device 100. In step S32, the feature extraction unit 11 extracts acoustic features of an input audio stream, such as mel-cepstrum.

In step S33, the division unit 14 receives the audio stream from which the features have been extracted, and divides the audio stream into audio segments (i.e., partial data pieces) with use of the aforementioned dividing method.

In step S34, the model estimation unit 15 receives the audio segments, and estimates a single Gaussian model for each audio segment with use of the aforementioned method. Gaussian models generated in advance based on the training data are stored as the training-data-based models 16 in the storage unit 21.

In FIG. 4, steps S41-S43 in the middle show the process of performing anchor model adaptation with use of test video data (hereinafter, also referred to as “test data”) provided by the user.

In step S41, the feature extraction unit 11 extracts acoustic features from the test video data provided from the user. Thereafter, the division unit 14 performs processing for dividing an audio stream into audio segments that each have a single acoustic feature.

In step S42, the model estimation unit 15 receives audio segments and estimates a single Gaussian model for each audio segment. Gaussian models generated in advance based on the training data are stored as the training-data-based models 16 in the storage unit 21. Accordingly, a Gaussian model group composed of numerous single Gaussian models is generated.

In step S43, the model clustering unit 18 performs high-speed clustering of single Gaussian models with use of the method shown in FIG. 3. During the high-speed clustering, the model clustering unit 18 performs adaptation (i.e., updating) of anchor models for the acoustic space, and thereby generates a new anchor model. According to the present embodiment, the model clustering unit 18 performs high-speed clustering of single Gaussian models based on a clustering method called a top-down tree-splitting method.

In FIG. 4, steps S51-S55 on the right side show the process of performing online clustering based on the anchor models after adaptation.

In step S51, test video data, which is audio video data for testing, is input by the user to the input unit 10. In step S52, the division unit 14 divides an audio stream in the test video data into audio segments that each have a single acoustic feature. The audio segments generated based on the test data are referred to as “test audio segments”.

In step S53, the mapping unit 12 maps the audio segments to the anchor models for the acoustic space. As described above, the mapping refers to calculating, for each frame within the current audio segment, the posteriori probability of the feature of the frame with respect to an anchor model for the acoustic space, adding the posteriori probabilities of the respective frames and thereby obtaining an additional value, and dividing the additional value by the total of the frames used for calculation.

In step S54, the AV clustering unit 13 performs clustering on audio segments based on the distance between the audio segments, with use of an arbitrary clustering algorithm. According to the present embodiment, the AV clustering unit 13 performs clustering with use of the clustering method called the top-down tree-splitting method.

In step S55, the AV clustering unit 13 outputs a category for a user to perform an operation, such as labeling, on the audio stream or the video data to which the audio stream belongs.

By performing online adaptation as described above, the anchor model adaptation device 100 generates an anchor model for the acoustic space, and appropriately categorizes an input audio stream with use of the anchor model.

<Example of Updating Anchor Model>

The following describes an image of an acoustic space model represented by anchor models that have been updated through the aforementioned online adaptation by the anchor model adaptation device according to the present invention.

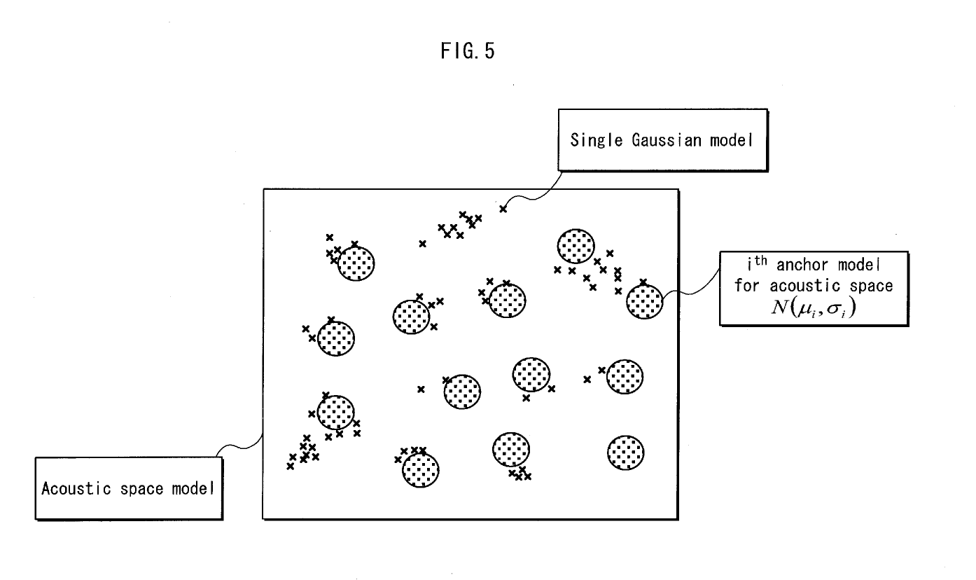

Assume here that FIG. 1 shows an image of an acoustic space model represented by anchor models of training data. Also, assume that FIG. 5 shows an image of an acoustic space model in which Gaussian models based on test data are added to the acoustic space shown in FIG. 1.

In FIG. 5, “x” marks indicate Gaussian models of audio segments of an audio stream. The audio segments are obtained by the anchor model adaptation device extracting the audio stream from video and dividing the audio stream. The Gaussian models indicated by the “x” marks are test-data-based Gaussian models.

At the time of adaptation of anchor models, the anchor model adaptation device according to the present embodiment generates a new anchor model with use of the aforementioned method. Specifically, the anchor model adaptation device generates a new anchor model from (i) the Gaussian models included in the pre-stored anchor models (i.e., Gaussian models in the anchor models indicated by the “o” marks in FIG. 5) and (ii) the Gaussian models generated from the test data (i.e., Gaussian models shown by the “x” marks in FIG. 5).

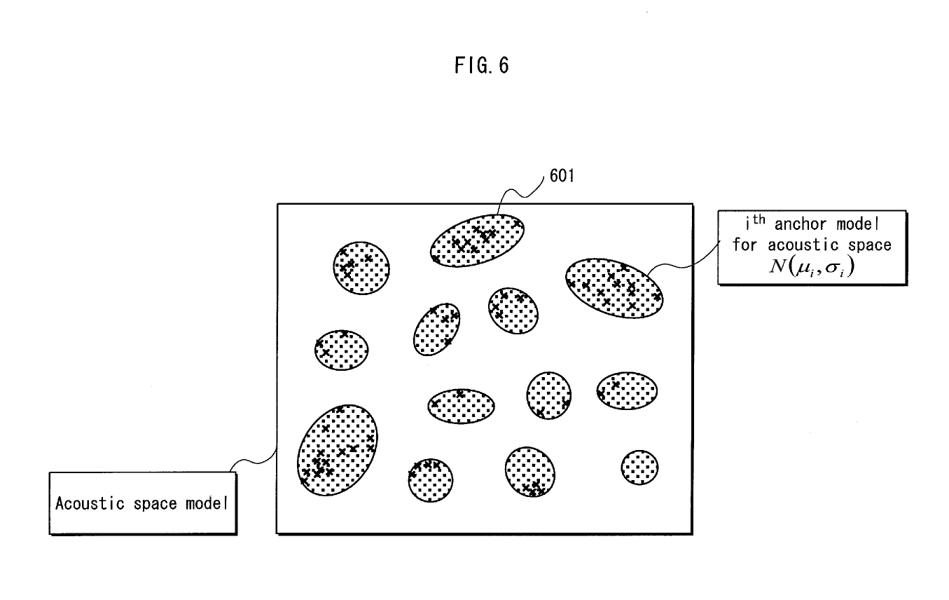

As a result, adaptation of anchor models performed by the anchor model adaptation device according to the present embodiment enables broader coverage of the acoustic space model using new anchor models, as shown in FIG. 6. As can be seen by the comparison between FIG. 1 and FIG. 6, parts of the acoustic space model, which cannot be represented by the anchor models in FIG. 1, are more appropriately represented by the anchor models in FIG. 6. For example, it is evident that, owing to an anchor model 601, the anchor models in FIG. 6 cover a broader area of the acoustic space model. Note that in the present embodiment, the number of anchor models of training data is the same as the number of anchor models after online adaptation. However, if the number of anchor models generated by online adaptation is larger than the number of anchor models of training data, the number of anchor models for the acoustic space is increased.

Accordingly, the anchor model adaptation device 100 in the present embodiment can provide anchor models that have enhanced adaptability to input audio streams as compared to the conventional technology and are suitable for respective users.

<Summary>

An anchor model adaptation device according to the present invention can update anchor models stored therein with use of an input audio stream. The anchor models thus updated can cover the entirety of the acoustic space including the Gaussian probability models representing the input audio stream. Anchor models are newly generated according to the acoustic features of an input audio stream. Therefore, newly generated anchor models vary depending on the type of an input audio stream. Accordingly, mounting the anchor model adaptation device in an AV device or the like enables videos to be categorized appropriately for each user.

<Supplementary Remark 1>

Although the present invention has been described based on the above embodiment, the present invention is of course not limited to such. In addition to the above embodiment, the following modifications are possible within the technical idea of the present invention.

(1) According to the above embodiment, the anchor model adaptation device generates a new anchor model from the anchor models already stored therein and the Gaussian models generated from an input audio stream. However, the anchor model adaptation device does not need to have stored therein anchor models in the initial state.

In this case, the anchor model adaptation device generates an anchor model in the following manner. First, the anchor model adaptation device acquires a predetermined amount of video data. To acquire video data, the anchor adaptation device connects to a recording medium or the like that stores a certain quantity of videos, and causes the videos to be transferred from the recording medium. Upon acquiring the predetermined amount of video data, the anchor model adaptation device analyzes the sounds of the video data, generates probability models for the sounds, and performs clustering on the probability models, thereby generating an anchor model from scratch. With this structure, the anchor model adaptation device cannot categorize videos until an anchor model is generated. However, this structure enables the anchor model adaptation device to generate a user-specific anchor model and categorize videos based on the user-specific anchor model.

(2) In the above embodiment, Gaussian models are taken as an example of probability models. However, the probability models are not necessarily Gaussian models as long as they can indicate posteriori probability models. For example, the probability models may be exponential distribution probability models.

(3) In the above embodiment, the feature extraction unit 11 specifies an acoustic feature every 10 milliseconds. However, a time interval for the feature extraction unit 11 to extract an acoustic feature is not necessarily 10 milliseconds, and may be a different time interval as long as acoustic features in the time interval are estimated to be similar to a certain degree. For example, the time interval may be longer than 10 milliseconds (e.g., 15 milliseconds) or shorter than 10 milliseconds (e.g., 5 milliseconds).

Similarly, the length of the sliding window used by the division unit 14 to divide an input audio stream is not limited to 100 milliseconds, and may be longer or shorter than 100 milliseconds as long as the length is sufficient enough for detecting a divisional point.

(4) In the above embodiment, acoustic features are represented by mel-cepstrum, but may be represented by other means. For example, acoustic features may be represented by LPCMC (linear prediction coefficient mel cepstrum) or another means without using mel scale.

(5) In the above embodiment, the AV clustering unit continuously generates new anchor models with use of the tree splitting method until the number of new anchor models reaches a predetermined number of 512. However, the number is not limited to 512. It is possible to set the number of anchor models to be larger than 512, such as 1024, so as to represent a broader acoustic space. Alternatively, the number of anchor models may be smaller than 512, such as 128, so as to conform to the capacity limitation of a storage for storing the anchor models.

(6) The anchor model adaptation device in the above embodiment or a circuit having the same function as the anchor model adaptation device may be mounted in AV devices, in particular an AV device capable of playing back videos, so as to increase the usability of the anchor model adaptation device or the circuit. Examples of AV devices include various types of recording/playback devices, such as a television having mounted therein a hard disk or the like for recording videos, a DVD player, a BD player, and a digital video camera. Also, in the case of such a recording/playback device as described above, the storage unit in the above embodiment corresponds to a recording medium such as a hard disk mounted in the recording/playback device. Also, an audio stream to be input in this case is of: a video obtained by receiving a television broadcast wave; a video recorded on a recording medium such as a DVD; a video obtained via a wired connection (e.g., an Ethernet cable) or a wireless connection; or the like.

In particular, sounds of a video captured by a user using a camcoder or the like are, in other words, sounds of a video captured based on the preference of the user. Accordingly, anchor models generated based on the sounds of the video are different from those generated based on sounds of a video captured by another user. Note that in the case of users having similar preferences, i.e., users capturing similar videos, anchor models generated by the anchor model adaptation devices mounted in the AV devices of the users become similar.

(7) The following is a brief description of the use of anchor models on which adaptation has been performed according to the above embodiment.

As described in the section of “technical problem” above, the anchor models are used to categorize input videos.

Alternatively, the anchor models may be used as follows. Suppose that a user is interested in a certain part of a video. In this case, a section that satisfies both of the following conditions (i) and (ii) is specified as user's interest section: (i) the section includes a time point corresponding to the part of the video in which the user is interested; and (ii) the section in which, based on an anchor model corresponding to the time point, acoustic features are estimated to be similar within a certain threshold.

Also, the anchor models may be used to extract a section of a video in which a user is estimated to be interested. Specifically, sounds included in a user's favorite video (i.e., a video designated by a user, a video frequently viewed by the user, etc.) are specified first. Then, acoustic features of the sounds are specified based on anchor models stored in the anchor model adaptation device. Then, from each of user's favorite videos, a section in which acoustic features are estimated to be similar to the specified acoustic features to a certain degree may be extracted so as to create a highlight video with use of the extracted sections.

(8) In the above embodiment, the timing at which online adaptation is performed is not specifically designated. However, online adaptation may be started every time an audio stream of a new video data is input or when the number of Gaussian models included in the test-data-based models 17 reaches a predetermined number (e.g., 1000). Alternatively, in the case of including an interface for receiving an input from a user, the anchor model adaptation device may start online adaptation upon receiving an instruction from the user.

(9) In the above embodiment, the adjustment unit 19 adjusts the anchor models generated as a result of clustering by the model clustering unit 18, and stores the adjusted anchor models in the storage unit 21 as the anchor models 20.

However, if adjustment of anchor models is not necessary, the anchor model adaptation device does not need to include the adjustment unit 19. In this case, the anchor models generated by the model clustering unit 18 may be directly stored into the storage unit 21.

Alternatively, the model clustering unit 18 may be provided with the adjusting function of the adjustment unit 19.

(10) The functional components of the anchor model adaptation device described in the above embodiment (e.g., the division unit 14, the AV clustering unit 13, etc.) may be realized by dedicated circuits, or software programs so as to enable a computer to perform functions of the functional components.

Also, each functional component of the anchor model adaptation device may be realized by one or more integrated circuits. The integrated circuits may be realized by semiconductor integrated circuits. Each semiconductor integrated circuit may be referred to as an IC (Integrated Circuit), an LSI (Large Scale Integration), an SLSI (Super Large Scale Integration), etc., in accordance with the degree of integration.

(11) A control program composed of program codes may be recorded on a recording medium or distributed via various communication channels or the like, the program codes being for causing a processor in a computer, an AV device, or the like, and circuits connected to the processor to perform operations pertaining to clustering, generating anchor models (see FIG. 4, etc.), etc. Examples of the recording medium include an IC card, a hard disk, an optical disc, a flexible disk, and a ROM. The control program thus distributed may be stored in a processor-readable memory or the like so as to be available for use. The functions described in the above embodiment are realized by a processor executing the control program.

<Supplementary Remark 2>

The following describes one aspect of the present invention and an advantageous effect thereof.

(a) A first aspect of the present invention is an anchor model adaptation device comprising: a storage unit (21) storing therein a plurality of anchor models (16 or 20) each composed of a different set of probability models, each probability model being generated from a sound having a single acoustic feature; an input unit (10) configured to receive an input of an audio stream; a division unit (14) configured to divide the audio stream into a plurality of audio segments, each being estimated to have a single acoustic feature; an estimation unit (15) configured to estimate a probability model (17) for each audio segment; and a clustering unit (18) configured to perform clustering on the probability models constituting the anchor models in the storage unit and the probability models estimated by the estimation unit, and thereby to generate a new anchor model.

A second aspect of the present invention is an online adaptation method for anchor models used in an anchor model adaptation device including a storage unit storing therein a plurality of anchor models each composed of a different set of probability models, each probability model being generated from a sound having a single acoustic feature, the online adaptation method comprising: an input step of receiving an input of an audio stream; a division step of dividing the audio stream into a plurality of audio segments, each being estimated to have a single acoustic feature; an estimation step of estimating a probability model for each audio segment; and a clustering step of performing clustering on the probability models constituting the anchor models in the storage unit and the probability models estimated by the estimation step, and thereby of generating a new anchor model.

A third aspect of the present invention is an integrated circuit comprising: a storage unit storing therein a plurality of anchor models each composed of a different set of probability models, each probability model being generated from a sound having a single acoustic feature; an input unit configured to receive an input of an audio stream; a division unit configured to divide the audio stream into a plurality of audio segments, each being estimated to have a single acoustic feature; an estimation unit configured to estimate a probability model for each audio segment; and a clustering unit configured to perform clustering on the probability models constituting the anchor models in the storage unit and the probability models estimated by the estimation unit, and thereby to generate a new anchor model.

A fourth aspect of the present invention is an audio video device comprising: a storage unit storing therein a plurality of anchor models each composed of a different set of probability models, each probability model being generated from a sound having a single acoustic feature; an input unit configured to receive an input of an audio stream; a division unit configured to divide the audio stream into a plurality of audio segments, each being estimated to have a single acoustic feature; an estimation unit configured to estimate a probability model for each audio segment; and a clustering unit configured to perform clustering on the probability models constituting the anchor models in the storage unit and the probability models estimated by the estimation unit, and thereby to generate a new anchor model.

A fifth aspect of the present invention is an online adaptation program indicating a processing procedure for causing a computer to perform online adaptation for anchor models, the computer including a memory storing therein a plurality of anchor models each composed of a different set of probability models, each probability model being generated from a sound having a single acoustic feature, the processing procedure comprising: an input step of receiving an input of an audio stream; a division step of dividing the audio stream into a plurality of audio segments, each being estimated to have a single acoustic feature; an estimation step of estimating a probability model for each audio segment; and a clustering step of performing clustering on the probability models constituting the anchor models in the memory and the probability models estimated by the estimation step, and thereby of generating a new anchor model.

According to the stated structure, a new anchor model is generated according to an input audio stream. In this way, an anchor model is generated that is appropriate for the preference of a user in viewing videos. This realizes online adaptation in which anchor models are generated such that each anchor model covers an acoustic space appropriate for a corresponding user. This prevents a situation in which, at the time of categorizing video data based on an input audio stream, the video data cannot be categorized or cannot be appropriately represented by anchor models that are stored.

(b) Regarding the anchor model adaptation device described in the item (a) above, the clustering unit may continuously generate new anchor models with use of a tree splitting method until a number of new anchor models reaches a predetermined number, and update the anchor models in the storage unit with the predetermined number of new anchor models.

With the stated structure, the anchor model adaptation device can generate the predetermined number of new anchor models. By performing online adaptation with the predetermined number being set to a number assumingly sufficient for representing the acoustic space, the acoustic space is sufficiently covered with use of anchor models necessary for representing an input audio stream.

(c) Regarding the anchor model adaptation device described in the item (a) above, the clustering unit may generate, with use of the tree splitting method, two new model centers based on a center of a model category having a greatest divergence distance, from among one or more model categories, generate, from the model category having the greatest divergence distance, two new model categories that each center on a respective one of the two new model centers, and generate the new anchor models by repeatedly splitting the model categories until a number of generated model categories reaches the predetermined number.

With the stated structure, the anchor model adaptation device can appropriately perform clustering on the probability models included in the anchor models stored in advance and the probability models estimated from the input audio stream.

(d) Regarding the anchor model adaptation device described in the item (a) above, the clustering unit may perform clustering by merging one of the probability models that has divergence smaller than a predetermined threshold from any of the anchor models stored in the storage unit, with one of the anchor models from which the probability model has a smallest divergence.

With the stated structure, if the number of probability models is too large, clustering is performed after the number of probability models is decreased. Since the number of probability models estimated from the audio stream is decreased, the amount of calculation performed for clustering is decreased as well.

(e) Regarding the anchor model adaptation device described in the item (a) above, the probability models may be either Gaussian probability models or exponential distribution probability models.

With the stated structure, the anchor model adaptation device according to the present invention can use, as a method for representing acoustic features, either Gaussian probability models which are generally used or exponential distribution probability models, thereby increasing versatility.

(f) Regarding the audio video device described in the item (a) above, the audio stream received by the input unit may be an audio stream extracted from video data, and the audio video device may further comprise a categorization unit (AV clustering unit 13) configured to categorize the audio stream with use of the anchor models stored in the storage unit.

This enables the audio video device to categorize an audio stream included in input video data. Since anchor models used for the categorization are updated according to the input audio stream, the audio video device can appropriately categorize the audio stream or the video data including the audio stream, thereby offering convenience for a user regarding sorting of the video data, or the like.

### INDUSTRIAL APPLICABILITY

The anchor model adaptation device according to the present invention is applicable to an electronic device for recording and playing back AV contents, and is provided for categorization of the AV contents, extraction of user's interest section from a video, or the like, the user's interest section being a section of the video in which a user is estimated to be interested.

### REFERENCE SIGNS LIST

100 anchor model adaptation device
11 feature extraction unit
12 mapping unit
13 AV clustering unit
14 division unit
15 model estimation unit
16 training-data-based models
17 test-data-based models
18 model clustering unit
19 adjustment unit
20 anchor models
21 storage unit

1. An anchor model adaptation device comprising:
a storage unit storing therein a plurality of anchor models each composed of a different set of probability models, each probability model being generated from a sound having a single acoustic feature;
an input unit configured to receive an input of an audio stream;
a division unit configured to divide the audio stream into a plurality of audio segments, each being estimated to have a single acoustic feature;
an estimation unit configured to estimate a probability model for each audio segment; and
a clustering unit configured to perform clustering on the probability models constituting the anchor models in the storage unit and the probability models estimated by the estimation unit, and thereby to generate a new anchor model.

2. The anchor model adaptation device of claim 1, wherein
the clustering unit continuously generates new anchor models with use of a tree splitting method until a number of new anchor models reaches a predetermined number, and updates the anchor models in the storage unit with the predetermined number of new anchor models.

3. The anchor model adaptation device of claim 2, wherein
with use of the tree splitting method, the clustering unit
generates two new model centers based on a center of a model category having a greatest divergence distance, from among one or more model categories,
generates, from the model category having the greatest divergence distance, two new model categories that each center on a respective one of the two new model centers, and
generates the new anchor models by repeatedly splitting the model categories until a number of generated model categories reaches the predetermined number.

4. The anchor model adaptation device of claim 1, wherein
the clustering unit performs clustering by merging one of the probability models that has divergence smaller than a predetermined threshold from any of the anchor models stored in the storage unit, with one of the anchor models from which the probability model has a smallest divergence.

5. The anchor model adaptation device of claim 1, wherein
the probability models are either Gaussian probability models or exponential distribution probability models.

6. An online adaptation method for anchor models used in an anchor model adaptation device including a storage unit storing therein a plurality of anchor models each composed of a different set of probability models, each probability model being generated from a sound having a single acoustic feature, the online adaptation method comprising:
an input step of receiving an input of an audio stream;
a division step of dividing the audio stream into a plurality of audio segments, each being estimated to have a single acoustic feature;
an estimation step of estimating a probability model for each audio segment; and
a clustering step of performing clustering on the probability models constituting the anchor models in the storage unit and the probability models estimated by the estimation step, and thereby of generating a new anchor model.

7. An integrated circuit comprising:
a storage unit storing therein a plurality of anchor models each composed of a different set of probability models, each probability model being generated from a sound having a single acoustic feature;
an input unit configured to receive an input of an audio stream;
a division unit configured to divide the audio stream into a plurality of audio segments, each being estimated to have a single acoustic feature;
an estimation unit configured to estimate a probability model for each audio segment; and
a clustering unit configured to perform clustering on the probability models constituting the anchor models in the storage unit and the probability models estimated by the estimation unit, and thereby to generate a new anchor model.

8. An audio video device comprising:
a storage unit storing therein a plurality of anchor models each composed of a different set of probability models, each probability model being generated from a sound having a single acoustic feature;
an input unit configured to receive an input of an audio stream;
a division unit configured to divide the audio stream into a plurality of audio segments, each being estimated to have a single acoustic feature;
an estimation unit configured to estimate a probability model for each audio segment; and
a clustering unit configured to perform clustering on the probability models constituting the anchor models in the storage unit and the probability models estimated by the estimation unit, and thereby to generate a new anchor model.

9. The audio video device of claim 8 further comprising
a categorization unit, wherein
the audio stream received by the input unit is an audio stream extracted from video data, and
the categorization unit is configured to categorize the audio stream with use of the anchor models stored in the storage unit.

10. An online adaptation program indicating a processing procedure for causing a computer to perform online adaptation for anchor models, the computer including a memory storing therein a plurality of anchor models each composed of a different set of probability models, each probability model being generated from a sound having a single acoustic feature, the processing procedure comprising:
an input step of receiving an input of an audio stream;
a division step of dividing the audio stream into a plurality of audio segments, each being estimated to have a single acoustic feature;
an estimation step of estimating a probability model for each audio segment; and
a clustering step of performing clustering on the probability models constituting the anchor models in the memory and the probability models estimated by the estimation step, and thereby of generating a new anchor model.
